(19) United States
(12) Patent Application Publication
(10) Pub. No.: US 2004/0202504 A1
(43) Pub. Date: Oct. 14, 2004

(54) Carrier plate designed for precut double-loop wire units and arrangement

(76) Inventor: Petri Mussalo, Heinola (FI)

Correspondence Address: YOUNG & THOMPSON, 745 SOUTH 23RD STREET 2ND FLOOR, ARLINGTON, VA, 22202

(21) Appl. No.: 10/796,959

(22) Filed: Mar. 11, 2004

(30) Foreign Application Priority Data
Sep. 11, 2002 (FI) 20021625

(51) Int. Cl. B42F 3/04

(52) U.S. Cl. 402/20

(57) ABSTRACT

A carrier plate (1) designed for precut double-loop wire units (4), is made of an elastic material. The carrier plate (1) comprises a frame (3), to which several elongate storage elements (5) are connected. The width (d) of the frame (51) of each elongate storage element (5) is roughly the same or smaller than the width (D) of the double-loop wire unit, and the length (l) of the frame (51) of the storage element is the same or slightly larger than the length (L) of the double-loop wire unit. Now adjacent storage elements are separated by a clearance (7), and the storage elements (5) are provided with retainer elements (2).

The invention relates to a carrier plate according to the preamble of claim 1, designed for precut double-loop wire units. The invention also relates to an arrangement according to the preamble of claim 8 for removing precut double-loop wire units from the carrier plate.

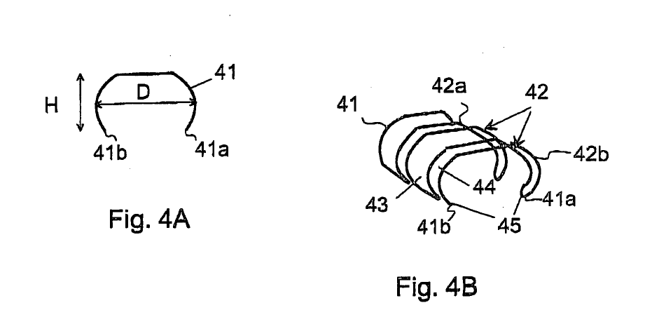

Precut double-loop wire units are used when binding exercise books, calendars and similar graphic articles. The binding is mostly carried out manually, so that the double-loop wire unit is inserted (threaded) in perforations provided at the edges of the pages of the article to be bound, whereafter the loops of the double-loop wire unit are pressed so that the ends of each loop meet, or at least shifted near to each other. As regards a more detailed structure of the double-loop wire, we refer to a specific part of the specification, particularly to FIGS. 4A and 4B, and their description. For binding and storage, the double-loop wire units are arranged on a suitable carrier plate, where they can be transported, and from where they can be removed one by one in the binding step. However, known carrier plates meant for precut double-loop wire units include several problems: in one of the most used carrier plate type, the “plate” is simply formed of several thin, elongate board or plastic strips that are arranged transversally to the lengthwise direction of the double-loop wire unit, between two successive pairs of double-loop wire loops. With this type of carrier plate, the problem is that single board strips are easily removed from between the pairs of loops. In another type of prior art carrier plate, described in the international patent application WO-9525047, the carrier plate is formed of a uniform material provided with retaining strips for the double-loop wire binding combs. This type of carrier plate is elastic, wherefore it is easily stacked, and it holds the binding combs well in place during transportation. However, the equipment needed for manufacturing the carrier plate is fairly expensive owing to the large number of retaining strips and the fairly complicated structure of the carrier plate, which means that the investment costs of the equipment easily rise high. Moreover, the removing of the binding combs from the carrier plate is relatively slow and cumbersome. In addition, in practice there is only one way of removing binding combs from the carrier plate—in other words, they must be picked from the carrier plate, so that the loop heads (cf. FIG. 4B) are removed from the retainer strips, and the binding combs are shifted outwards, at right angles to the level defined by the carrier plate plane. In addition, in a practical usage situation, the binding combs placed on the carrier plate must also be positioned so that their loop heads point directly downwards, i.e. the carrier plate faces directly upwards, in order to facilitate the picking of the binding combs from the carrier plate (and later also from the storage plate) so that it should not be too troublesome. Consequently, in the prior art the properties of the carrier plate largely define in what position the article to be bound should be arranged during the binding operation, with respect to the person who performs the binding.

The object of the invention is to eliminate the drawbacks of the prior art described above. Thus a first object of the invention is to realize a carrier plate for precut double-loop wire units, where said double-loop wire units can be stored and transported without the risk of getting the wires mixed up. A second object of the invention is to realize an elastic carrier plate that can be folded for instance for the storage of said carrier plate. A third object of the invention is to realize a carrier plate that has a simple structure and low manufacturing expenses. A fourth object of the invention is to realize a carrier plate from which precut double-loop wire units can be picked rapidly and easily. A fifth object of the invention is to realize a carrier plate from which double-loop wire units can be picked in a flexible manner, so that the carrier plate and the double-loop wire units positioned on it point in a desired direction with respect to the picking person and/or with respect to the horizontal plane, and from which carrier plate the double-loop wire units can thereafter be transferred into different directions according to the demands of the binding process.

The above described advantages are achieved by using a carrier plate according to claim 1. A carrier plate according to the invention, designed for precut double-loop wire units, is made of an elastic material. The carrier plate comprises a frame with several elongate storage elements, the width d whereof is roughly the same or smaller than the width D of the double-loop wire unit, and the length 1 of the storage elements is the same or larger than the length L of the double-loop wire unit. Now the adjacent storage elements are separated by a clearance, and the storage elements are provided with retainer elements.

In a preferred embodiment of the invention, the retainer elements are formed of a nodule arranged at the bottom part of each storage element, which nodule is advantageously positioned on the narrow side of the storage element frame.

The invention is based on the idea that generally the carrier plate designed for double-loop wire units has a rectangular frame, and to said frame there are connected elongate storage elements provided with retainer elements. The double-loop wires are simply slipped on the storage elements, and the retainer elements provided therein lock the double-loop wires in place. Several advantages are achieved by using this kind of carrier plate. Because of the retainer elements, the double-loop wires are held safely on the storage elements during transportation, but they are still easily obtained for use owing to the shape and structure of the retainer elements. In structure, the carrier plate is simple, which means that the investing costs remain low. The carrier plate can be folded due to its elasticity and to the clearances separating the storage elements.

In an arrangement according to the invention, the double-loop wire units are removed from the carrier plate by pulling them in the direction of the lengthwise axis of the elongate storage elements, away from the carrier plate frame. In a preferred embodiment of an arrangement according to the invention, the direction of the plane of the carrier plate frame with respect to the horizontal plane is within the range 0-180 degrees, when the double-loop wire units are removed from the carrier plate. Thus the carrier plate according to the invention does not—unlike in the prior art—define in which position the article to be bound, the employer and the carrier plate can be with respect to each other, when double-loop wire is picked from the elongate storage elements prior to the binding operation. In this way, there is achieved the remarkable advantage that the double-loop wire can be taken from the carrier plate in a position that is optimal both for the employer and the working process. The removal of the double-loop wire by simply pulling it in the direction of the lengthwise axis of the storage elements, away from the carrier plate frame, is carried out remarkably more rapidly and easily than the removal of the double-loop wire from the carrier plate according to the described international application, where the retainer elements of the carrier plate are formed of several retaining strips, of which the double-loop wire must first be removed before it can be used. In a carrier plate according to the invention, each storage element advantageously comprises one or several semicircular, nodule-like formations near the carrier plate frame. The shape of the retainer element prevents the double-loop wire from sliding away from the storage element, but still allows a swift removal of the double-loop wire from the storage element in a situation where it is taken to use.

As for the additional advantages achieved by the invention, let us point out the following: the carrier plate can also be stored in a vertical position, from where said carrier plates are easily taken to use. One and the same carrier plate can also be used for precut double-loop wire units of different lengths.

The invention is described in more detail below with reference to the appended drawings.

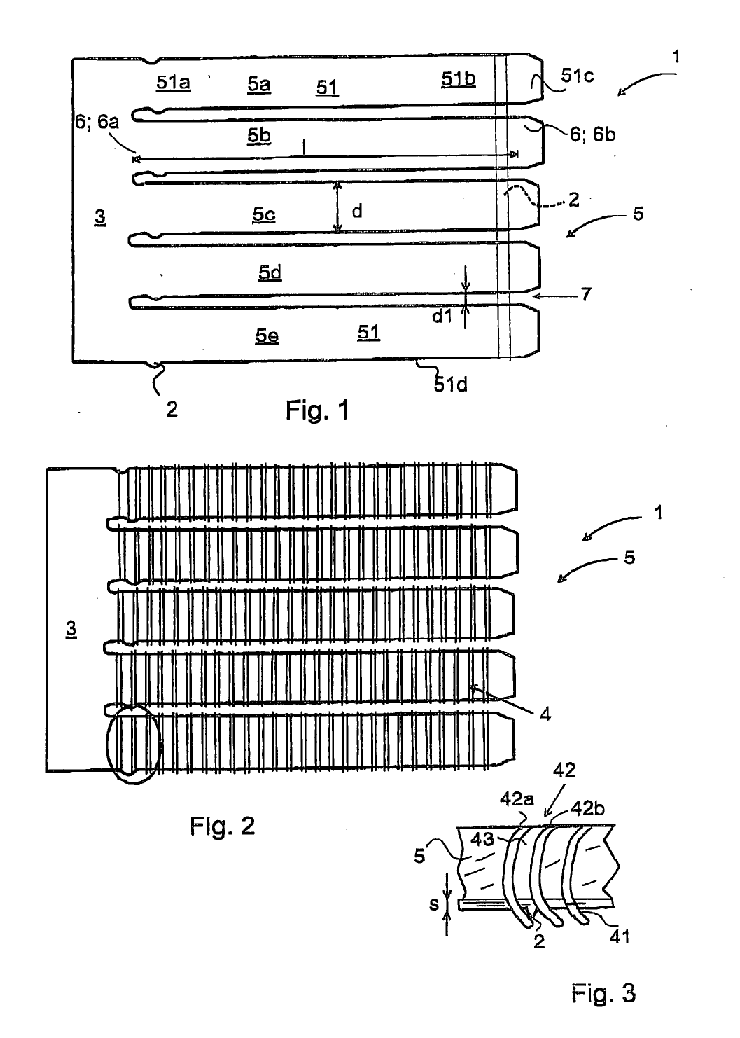

FIG. 1 is a top-view illustration of a carrier plate according to the invention.

FIG. 2 illustrates the carrier plate of FIG. 1, provided with precut double-loop wire units.

FIG. 3 illustrates the detail encircled in FIG. 2 as a perspective drawing.

FIG. 4A illustrates a single chain of a double-loop wire unit, viewed directly towards the end of the chain.

FIG. 4B is perspective drawing of an element of a double-loop wire unit.

Let us now first briefly deal with the structures illustrated in the different drawings.

FIG. 1 illustrates an embodiment of a carrier plate 1 according to the invention. The carrier plate 1 comprises a rectangular frame 3, including five elongate storage elements 5; 5a . . . 5e. The bottom part 51a of the frame 51 of the storage elements 5 is provided with retainer elements 2 for holding the double-loop wire units arranged in the storage elements of the carrier plate.

FIG. 2 illustrates how the precut double-loop wire units 4 are arranged on the carrier plate illustrated in FIG. 1. The double-loop wire units are held on the storage elements 5 owing to the retainer elements 2.

FIG. 3 illustrates the structure and operation of a retainer element 2.

FIG. 4A illustrates the shape of one chain 41 of a precut double-loop wire unit that is conventional as such, viewed directly towards the chain end. The double-loop wire unit chain is bent in the form of an open ellipse.

FIG. 4B illustrates the shape and structural details of a precut double-loop wire unit 4 known as such. The double-loop wire unit 4 is formed of chain pairs 42, where successive chain pairs are always separated by a given distance 43.

FIG. 1 illustrates a carrier plate 1 according to the invention, designed for double-loop wire units 4, the material of which carrier plate is board. The carrier plate is sufficiently rigid for transporting double-loop wire units 4, but yet sufficiently elastic, in case the carrier plate should be folded for instance for storage. A carrier plate 1 according to the invention comprises a rectangular frame 3, provided with five elongate storage elements 5; 5a, 5b. 5c, 5d, 5e. In all individual storage elements 5a . . . 5e, the width d and length l of the frame 51 is the same. Advantageously the frame 51 of the storage elements is structurally uniform and homogeneously wide. The length l of the frame 51 of each storage element 5; 5a . . . 5e is the length as measured from the bottom part 51a of the storage element frame 51 to the top part 51b of the frame. When the storage elements 5 are observed from the direction of the carrier plate frame 3, in the bottom parts of said storage elements, near the carrier plate frame 3, there are provided retainer elements 2. A retainer element is located at one side 51d of the frame 51 of each storage element 5; 5a . . . 5e, and said retainer element 2 is a nodule-like, semicircular formation. The function of the retainer element 2 is described in more detail in FIG. 3. According to FIG. 3, the retainer element is arranged between 43 two successive chain pairs 42; 42a, 42b of the double-loop wire unit 43, when the double-loop wire unit is arranged on the storage element 5. The retainer element 2 prevents the double-loop wire unit from sliding away from the storage element 5 during transportation. From FIG. 3, it is also apparent that the thickness s of the carrier plate storage elements 5 is remarkably smaller than the height of the double-loop wire unit loops 4 (the loops are dealt with in more detail below, in connection with the description of FIGS. 4A and 4B). In that case the thickness of the storage element does not restrict the shape of the double-loop wire unit in the height direction.

The top part 51b of the storage element frames extends as a narrowing end part 51c of the frame. The narrowing frame end part 51c facilitates the slipping of the double-loop wire unit 4 on the storage element frame 51. Said part of the storage element frame 51 that is equally wide, having a width d, starts from the junction 6; 6a of the bottom part 51a of the frame 51 and the carrier plate frame 3, and ends at the junction of the top part 51b of the storage element frame 51 and the narrowing end part 51c of the frame 51. The storage elements are separated by a given distance 7 having a width d1. The width d1 must be so wide that the double-loop wire units 4 arranged on the storage elements 5; 5a . . . 5e do not obstruct each other's motions when they are set on the storage elements or removed therefrom. In FIG. 1, there also is illustrated, marked by a dotted line, an alternative way for realizing the retainer elements 2, where the retainer elements are formed of a tape attached to the top part 51; 51b of the storage elements 5, which tape prevents the double-loop wire units 4 that are slipped on the storage elements from sliding away from the storage elements 5. Said tape can as well be attached to the end part 51c of the frame of the storage elements.

FIG. 2 illustrates a carrier plate 1, on the storage elements 5 of which there are slipped the double-loop wire units 4. The double-loop wire units are slipped on the storage elements through the narrowing end part 51; 51c of the storage elements. Generally the double-loop wire units are slipped on the storage elements so that their heads (illustrated in FIG. 4B) point in the same direction; in the drawing the double-loop wire unit heads point downwards, but they could as well be arranged on the carrier plate 1 according to the drawing so that their heads should point upwards. The retainer elements of the storage elements of the carrier plate hold the double-loop wire units equally well, irrespective of the direction in which they are positioned on the storage elements. The structure of the precut double-loop wire units to be slipped on the carrier plate storage elements is illustrated in more detail in FIGS. 4A and 4B. As such, the structure of the double-loop wire units is conventional, and their shape can differ from the one illustrated in FIG. 4. Generally the double-loop wire is made of a rigid metal wire and bent into several loops illustrated in FIG. 4A, which loops further form several loop pairs including two successive loops, illustrated in FIG. 4B. In shape, each single loop 41 of the double-loop wire unit 4 resembles the loop described in FIG. 4A, i.e. a semicircle or a partial ellipse, in which case said semicircle or partial ellipse does not, however, include a head. This kind of an open double-loop wire loop 41 has ends 41a and 41b, which are pressed together or nearly together, when the double-loop wire unit is used for binding a book. The double-loop wire is formed of identical loops 41. A single loop of the double-loop wire has a given width D when measured at the widest point, and said width D is larger or roughly the same as the width d of a single storage element. FIG. 4B illustrates two first loop pairs 42; 42a, 42b of the double-loop wire unit, where the loop pairs are formed of identical loops 41. According to FIG. 4B, in each loop pair 42 the loops 41 are placed adjacently, and between them there is left a first clearance 44 that is fairly narrow. The other end of the loop pair is always closed by the double-loop wire connecting the loops 41 of the loop pair 42, while the other end remains open. Successive loop pairs are separated by a given second clearance 43, which clearance is larger than the distance between single loops 41 of the loop pair. The ends 41a and 41b of the loops 41 together form the head 45 of the double-loop wire. Let us now return to the description of FIG. 2. The double-loop wire unit 4 is slipped on the carrier plate storage element, so that the retainer element 2 is left between two successive loop pairs 42; 42a, 42b of the double-loop wire unit 4, as is illustrated in FIG. 3. As was explained above, the double-loop wire can be arranged on the storage element, so that the heads 45 of its loops 41 are pointed either upwards or downwards. Owing to the holding effect of the retainer element 2, the double-loop wire unit 4 remains well on the storage element for example during transportation. When the double-loop wire unit 4 is taken into use for instance when binding an exercise book or other graphic article, the elastic double-loop wire unit made of thin metal is easily pulled away from the storage element 4 owing to the round shape of the retainer element 2.

In the above specification, there is described only one preferred embodiment of the invention, and it is obvious for a man skilled in the art that the invention can also be realized in many other ways within the scope of the inventive idea set forth in the claims.

Thus the carrier plate frame 3 can include one or several hanging means, such as apertures, through which the carrier plate can be hanged in a suitable rack either for usage or for storage. Likewise, the number of the storage elements 5 and the shape of the end part may deviate from what is explained above. The number of the storage elements connected to the carrier plate frame depends on how wide are the double-loop wire units 4 that should be stored on the storage elements; in case the width of the double-loop wire units is small, several storage elements 5 can be connected to the same carrier plate frame 3. A carrier plate provided with equally long storage elements can be used for storing different lengths of precut double-loop wire units, in case the double-loop wires only have a roughly similar shape and width D. Advantageously the material of the carrier plate is fairly rigid, but still bendable, such as plastic or board. However, in some special applications, a material that is even more rigid, such as metal, can be considered. The double-loop wire units are made of a suitable rigid material, such as metal, but also plastic double-loop wire units can be used. In a preferred embodiment of the invention, the carrier plate frame is provided with small perforations at the storage elements, due to technical reasons of the system.

1. A carrier plate (1) designed for precut double-loop wire units (4), which carrier plate is made of an elastic material, characterized in that the carrier plate (1) comprises
a frame (3), to which there are connected several elongate storage elements (5),
the width (d) of the frame (51) of each elongate storage element (5) is roughly the same or smaller than the width (D) of the double-loop wire unit, and the length (l) of the frame (51) of the storage element (5) is the same or larger than the length (L) of the double-loop wire unit, so that
adjacent storage elements are separated by a clearance (7) and
the storage elements (5) are provided with retainer elements (2).

2. A carrier plate according to claim 1, characterized in that the retainer elements (2) are formed of nodules placed at the bottom part (51; 51c) of each storage element frame, which nodules are advantageously located at the side (51d) of the storage element frame (51).

3. A carrier plate according to claim 1, characterized in that the retainer elements (2) are formed of a tape attached in the vicinity of the end part (5; 51c) of the storage elements (5).

4. A carrier plate according to claim 1, characterized in that the carrier plate (1) is plastic or board.

5. A carrier plate according to claim 1, characterized in that the carrier plate thickness (s) is smaller than the height (H) of the chain (41) of the double-loop wire unit (4).

6. A carrier plate according to claim 1, characterized in that in shape, the carrier plate frame (3) is a rectangle or a semicircle.

7. A carrier plate according to claim 1, characterized in that the width (d) of the frame (51) of the storage elements (5) remains essentially the same from the junction (6; 6a) of the carrier plate frame (3) and the storage element frame (51) as far as the beginning (6; 6b) of the end part of the storage element frame, i.e. the tip (51c).

8. An arrangement for removing precut double-loop wire units (4) from a carrier plate (1), said carrier plate being made of an elastic material, characterized in that the carrier plate (1) comprises
a frame (3), to which there are connected several elongate storage elements (5),
the width (d) of the frame (51) of each elongate storage element (5) is roughly the same or smaller than the width (D) of the double-loop wire unit, and the length (l) of the frame (51) of the storage element (5) is the same or larger than the length (L) of the double-loop wire unit, so that
adjacent storage elements are separated by a clearance (7), and
the storage elements (5) are provided with retainer elements (2)
the double-loop wire units (4) are removed from the carrier plate by pulling them along the lengthwise axis of the elongate storage elements, away from the frame (3) of the carrier plate.

9. An arrangement according to claim 8, characterized in that with respect to the horizontal plane, the direction of the plane defined by the carrier plate frame (3) is between 0-180 degrees, when the double-loop wire units are removed from the carrier plate.
